(19) United States
(12) Patent Application Publication
(10) Pub. No.: US 2016/0346155 A1
(43) Pub. Date: Dec. 1, 2016

(54) MULTI-VECTOR TRACTION DEVICE FOR THE LUMBAR SPINE

(71) Applicant: Matthew James Brown, Dallas, TX (US)

(72) Inventor: Matthew James Brown, Dallas, TX (US)

(21) Appl. No.: 15/227,790

(22) Filed: Aug. 3, 2016

Related U.S. Application Data
(63) Continuation-in-part of application No. 14/659,256, filed on Mar. 16, 2015.
(60) Provisional application No. 61/954,475, filed on Mar. 17, 2014.
(60) Provisional application No. 62/046,054, filed on Sep. 4, 2014.

(51) Int. Cl. A61H 1/02

(52) U.S. Cl. CPC A61H 1/0292; A61H 2201/1626; A61H 2201/164; A61H 2201/1619; A61H 2201/1676; A61H 2203/045

(57) ABSTRACT

Some embodiments of the present disclosure include a traction device for relieving lower back pain and stiffness and reducing lumbar spine intervertebral disc displacement. The device may include a sliding spine assembly attached to a head rest pad, a torso pad, and a hip pad, an adjustable length vector bar extending outwardly from the spine assembly, wherein the vector bar is rotatably attached to the sliding spine assembly such that the vector bar is configured to move in a plurality of vectors, a cross bar foot brace tube attached to the vector bar; a foot rest positioned on the foot brace tube, a belt positioned proximate to the torso pad, and a strap assembly attached to the foot brace tube or the distal end of the vector bar, the strap assembly configured to attach to the belt and apply traction to a user's back.

### RELATED APPLICATIONS

This application is a continuation in part of U.S. Non-provisional patent application Ser. No. 14/659,256 which, in turn, claims priority to provisional patent applications U.S. Ser. No. 61/954,475 filed on Mar. 17, 2014 and U.S. Ser. No. 62/046,054 filed on Sep. 4, 2014, the entire contents of each of which is herein incorporated by reference.

### BACKGROUND

The embodiments herein relate generally to back pain relief, and more particularly, to a device providing for the application of multi-vector, auto-powered traction by a user to his or her lumbar spine.

Lower back pain is a leading cause of work disability and lost productivity. Treatments are complex and costly. Most lumbar spine conditions require repetitive, ongoing physical training and decompression. Conventional devices designed to provide such physical training and decompression only provide pure longitudinal traction along a flat plane and anchor under the arms and ankles, which limits the direction of force to only a single plane of traction. However, lumbar spine disc and facet join lesions are typically asymmetrical and varied in their presentation. A single plane of traction can only provide traction in one direction and cannot be tailored to the many variables presented by the user. Moreover, these devices also are not comfortable for the user. Motorized systems are set to apply force at a pre-determined setting, which is not based on the comfort of the user.

Therefore, what is needed is a multi-vector, auto-powered device configured to provide spine traction/distraction, stretching, and decompression forces to the lumbar, thoracic, and cervical spine.

### SUMMARY

Some embodiments of the present disclosure include a traction device for relieving lower back pain and stiffness and reducing lumbar spine intervertebral disc displacement. The device may include a sliding or gliding spine assembly attached to a head rest pad, a torso pad, and a hip pad, an adjustable length vector bar extending outwardly from the spine assembly, wherein the vector bar is rotatably attached to the sliding spine assembly such that the vector bar is configured to move in a plurality of vectors, a cross bar foot brace tube attached to the vector bar; a foot rest positioned on the foot brace tube, a belt positioned proximate to the torso pad, and a strap assembly attached to the foot brace tube or the distal end of the vector bar, the strap assembly configured to attach to the belt and apply traction to a user's back.

### BRIEF DESCRIPTION OF THE FIGURES

The detailed description of some embodiments of the invention is made below with reference to the accompanying figures, wherein like numerals represent corresponding parts of the figures.

FIG. 1 is a top perspective view of one embodiment of the present invention.

FIG. 2 is a bottom perspective view of one embodiment of the present invention.

FIG. 3 is a detail perspective view of one embodiment of the present invention.

FIG. 4 is a detail perspective view of one embodiment of the present invention.

FIG. 5 is a detail perspective view of one embodiment of the present invention.

FIG. 6 is an exploded detail view of one embodiment of the present invention.

FIG. 7 is a perspective detail view of one embodiment of the present invention, shown in an exemplary initial state.

FIG. 8 is a perspective detail view of one embodiment of the present invention, shown in an exemplary secondary state.

FIG. 9 is a top view of one embodiment of the present invention, shown in use and demonstrating a straight vector.

FIG. 10 is a top view of one embodiment of the present invention, shown in use and demonstrating a left vector.

FIG. 11 is a side view of one embodiment of the present invention.

FIG. 12 is a side view of one embodiment of the present invention, demonstrating a partial press.

FIG. 13 is a side view of one embodiment of the present invention, demonstrating a full leg extension press.

FIG. 14 is a side view of one embodiment of the present invention.

FIG. 15 is a side perspective view of one embodiment of the present invention.

FIG. 16 is a side perspective view of one embodiment of the present invention.

FIG. 17 is a top view of one embodiment of the present invention shown in use.

FIG. 18 is a side perspective view of one embodiment of the present invention shown in use.

FIG. 19 is a side perspective view of one embodiment of the present invention shown in use.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to relieve lower back pain, reduce lumbar spine intervertebral disc displacement, and relieve lower back stiffness and may comprise the following elements: (i) Torso Board, Hip Board, and Head Rest; (ii) Adjustable Vector Bar; (iii) Belt; and (iv) Strap Assembly. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

The various elements of the traction device of the present disclosure may be related in the following exemplary fashion. It is not intended to limit the scope or nature of the relationships between the various elements and the following examples are presented as illustrative examples only.

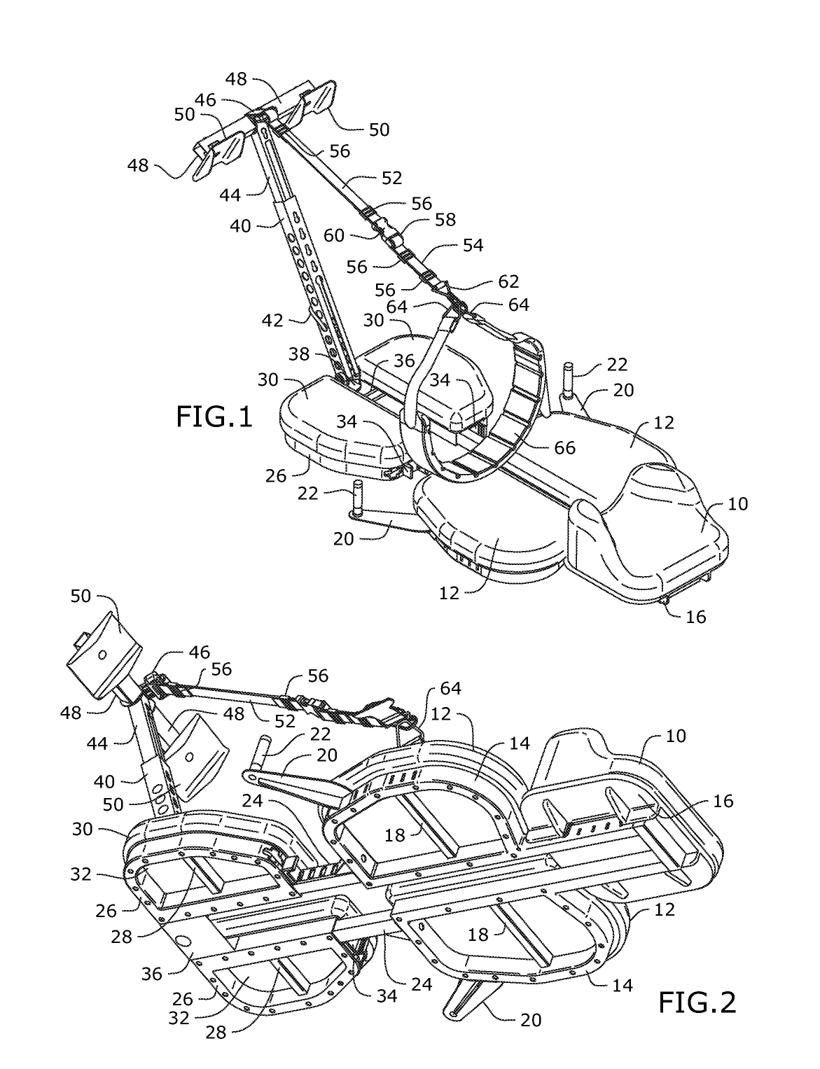

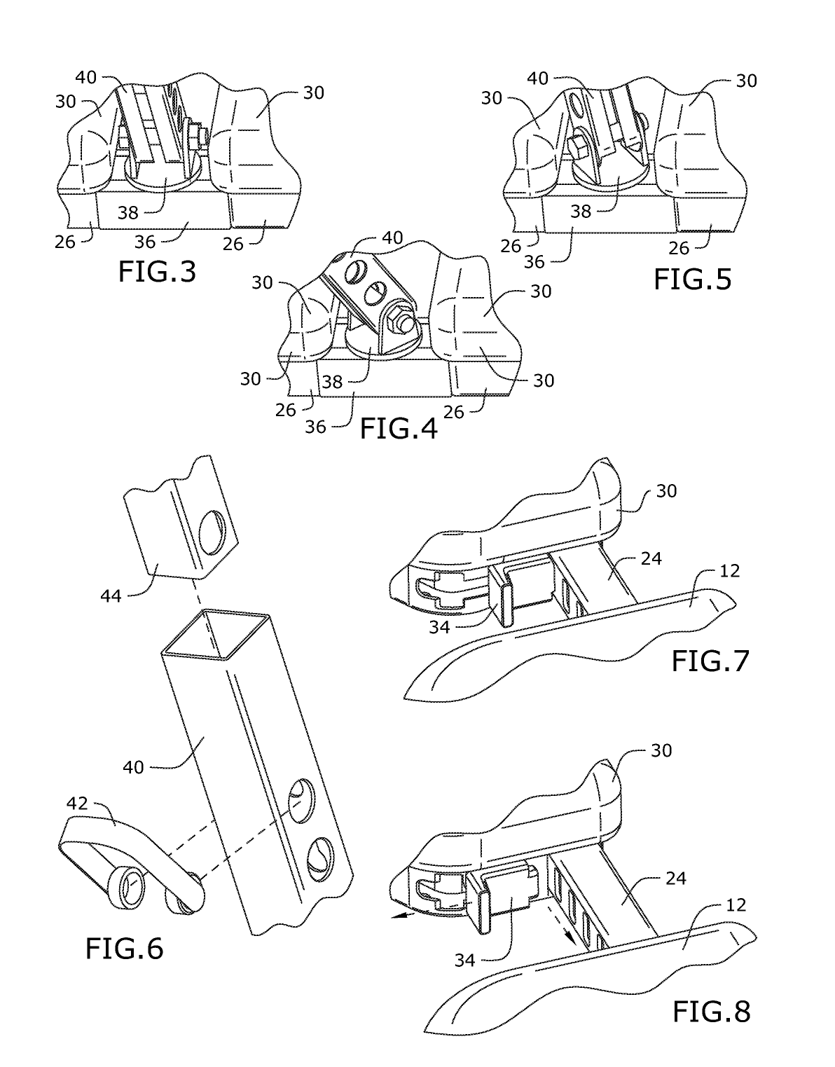

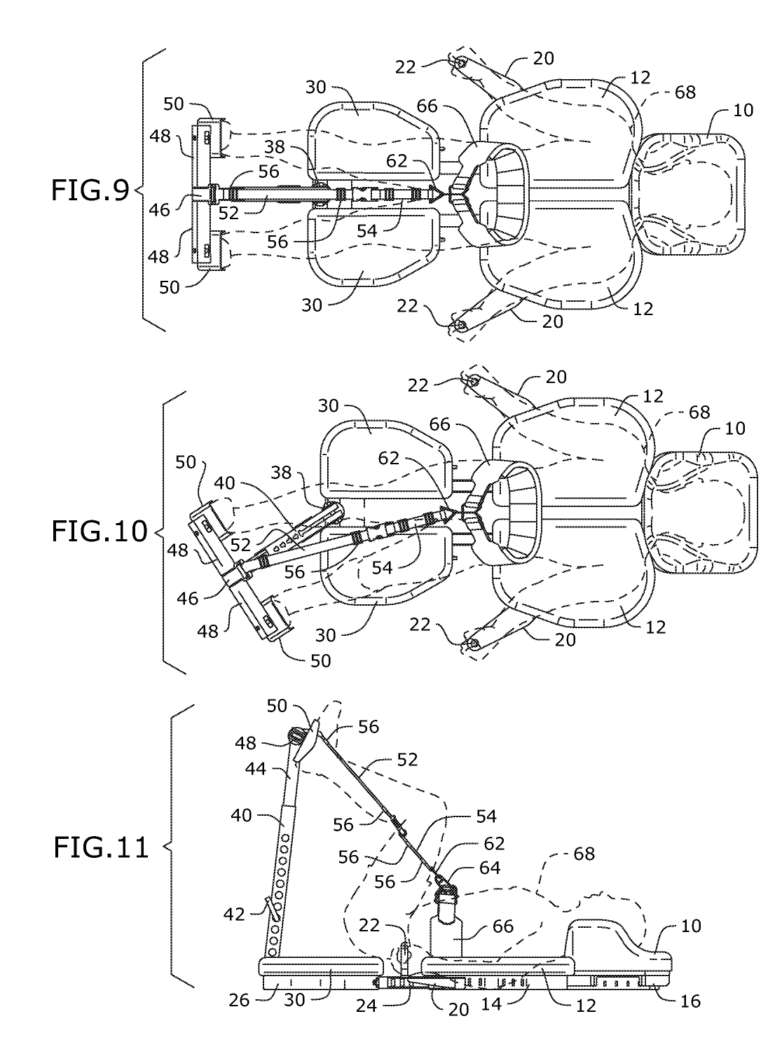

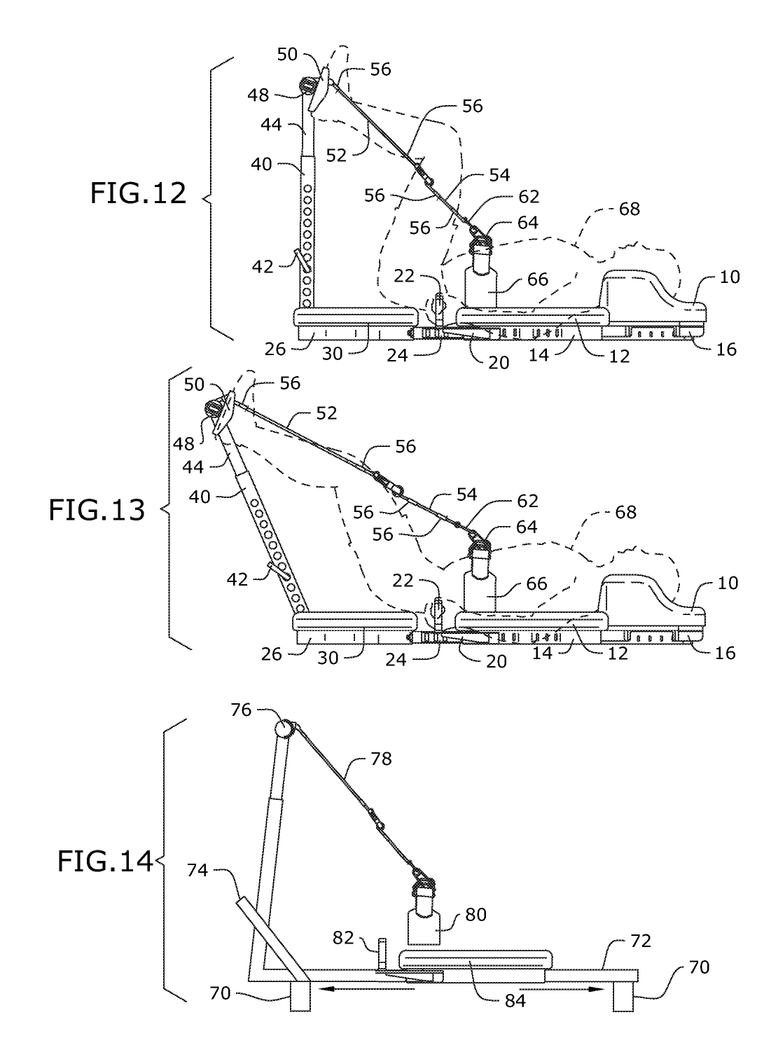

By way of example, and referring to FIGS. 1-14, some embodiments of the traction device for relieving lower back pain and stiffness, releasing muscle fascia adhesions, and reducing lumbar spine intervertebral disc displacement of the present disclosure comprise a sliding spine assembly 24; a head rest pad 10, a torso pad 12, and a hip pad 30 attached to the spine assembly 20, the head rest pad 10 being attached to a first end of the spine assembly 20, the hip pad 30 being attached proximate to a second end of the spine assembly 20, and the torso pad 12 being positioned between the head rest pad 10 and the hip pad 30; an adjustable length vector bar extending outwardly from the second end of the spine assembly 24, wherein the adjustable length vector bar may comprise a substantially hollow split rectangular tube 40 configured to accept and engage with a leg press tube 40, wherein the leg press tube 40 may be locked in a desired position using a locking mechanism, such as a yoke lock 42 and may comprise a foot end cap 46 positioned at an end thereof, and wherein the vector bar may be rotatably attached to the spine assembly 20, such as by using a U-joint 38 configured to engage with a U-joint base 26 on the sliding spine assembly 20; a cross bar foot brace tube 48 attached to an end of the vector bar distal from the spine assembly 20; a pair of foot rests 50 positioned on foot brace tube 48; belt 66 attached to, or positioned proximate to, the torso pad 12; and a strap assembly attached to the foot brace tube 48 or to the distal end of the vector bar, the strap assembly configured to attach to the belt 66, wherein when a user 68 is positioned on the traction device, the belt 66 is configured to encircle the user 28, the user's feet are positioned against the foot rests 50, and the strap assembly is configured to apply traction to the belt 66, which may be aligned with the user's lumbar spine. The user 68 may alter the traction provided to the belt 66 by moving the vector bar to multiple vectors from the user's midline, as shown in FIGS. 9-13. Alternatively, in other embodiments, the vector bar may remain substantially stationary and the user may vary the traction provided to the belt 66 by sliding the torso pad 12 along the sliding spine assembly 24, in a fashion similar to a rowing machine. In some embodiments, the traction device may further comprise a pair of handles 22 extending outwardly from a handle bracket 20, which may be attached to the torso pad 12, providing the user 68 with handles to help with stability and positioning during use of the device. Thus, embodiments of the device may not require a motor or other electronic components to be used properly.

In embodiments, the head rest pad 10 may be supported by a head rest frame comprising a head rest bracket 16, as shown in FIGS. 1 and 2. The head rest bracket 16 may be attached to the first end of the sliding spine assembly 24. In some embodiments, the head rest pad 10 may be contoured to comfortably accommodate a user's head.

In embodiments, the torso pad 12 may be supported by a torso pad frame attached to the sliding spine assembly 24, the torso pad frame comprising a pair of curved torso tubes 14 attached proximate to outer edges of the bottom surface of the torso pad 12, defining an interior region of the torso pad 12, and a torso support tube 18 configured to bisect the interior region, as shown in FIG. 2. The torso pad 12 may be attached to the sliding spine assembly 24, such that the torso pad 12 remains stationary while the traction device is in use, as shown in FIGS. 1-13.

In embodiments, the hip pad 30 may be supported by a hip pad frame attached proximate to the second end of the sliding spine assembly 24, the hip pad frame comprising a hip board 32 onto with the hip pad 30 is adhered or otherwise attached, a pair of curved hip tubes 26 attached proximate to the outer edges of the bottom surface of the hip board 32, defining an interior region of the bottom surface of the hip board 32, and a hip support tube 28 configured to bisect the interior region, as shown in FIG. 2. The curved hip tubes 26 may each comprise a substantially straight portion, wherein the substantially straight portion may be configured to accommodate a length of the sliding spine assembly 24, such that the sliding spine assembly 24 may telescopically extend outwardly from the curved hip tubes 26. As shown in FIGS. 7 and 8, the hip pad 30 may comprise a locking mechanism to locking the sliding spine assembly 24 into its desired configuration. As shown in the Figures, the locking mechanism may comprise a hip lock 34 configured to engage with locking orifices in the sliding spine assembly 24.

As described above, the strap assembly may be attached to the foot brace tube 48 or to the distal end of the vector bar, wherein the strap assembly is configured to attach to the belt 66. For example, as shown in FIGS. 1, 2, and 9-13, the strap assembly may comprise a first strap 54 attached to the belt 66 and a second strap 52 attached to the leg press tube 44, wherein the first strap 54 and the second strap 52 are configured to removably attach to one another using a fastener, such as a buckle having a female portion 58 and a male portion 60. The straps 52, 54 may also comprise a plurality of clips 56 that allow a user 68 to adjust the length of each strap 52, 54. As shown in the Figures, the first strap 54 may comprise a ring, such as an angular carabineer 62, positioned at an end of the first strap 54 distal from the foot brace tube 48, wherein the angular carabineer 62 may be removably attached to a pair of belt rings 64 on the belt, wherein when the angular carabineer 62 is attached to the belt rings 64, the belt 66 may be secured around a user's waist. The straps 52, 54 may be made of any desirable material and, in some embodiments, comprise an elastic material.

As described above, the belt 66 may comprise a mechanism, such as belt rings 64, for attaching to the first strap 54. The belt rings 64 may be positioned at opposite ends of the belt 66, as shown in the Figures. The belt 66 may be made of any suitable or desired material and, in some embodiments, comprises curved foam.

Both the sliding spine assembly 24 and the vector bar may be adjustable in length to accommodate users of different sizes. For example, the sliding spine assembly 24 and the vector bar may each telescope to achieve the necessary length, wherein the sliding spine assembly 24 and the vector bar may be secured in the desired position using a locking mechanism, such as a yoke lock 42 or a hip lock 34, wherein the locking mechanism may be configured to engage with locking orifices on the sliding spine assembly 24 and the vector bar, respectively. The vector bar may comprise a range of motion resulting from its ability to pivot at the connection point between the vector bar and the sliding spine assembly 24 due to, for example, the U-joint 38 assembly. The range of motion may comprise multiple vectors relative to a user's midline or to the joint between the vector bar and the sliding spine assembly.

In embodiments, the traction device may optionally include a digital/mechanical force meter/scale to measure to number of pounds of force being applied, wherein the meter/scale may be attached to the device at any location viewable by the user. An optional counter-lever bar could articulate to the base of the vector bar to provide cephalad traction to the upper torso, thoracic spine, and/or cervical spine/occiput/cranium. In some embodiments, optional elastic material such as bungee cords could attach between the head support and the head end of the table to provide a cephalad directional traction force.

As shown in FIG. 14, alternate embodiments may comprise a pad that glides along a frame of the traction device, rather than a device that includes stationary pads, as shown in FIGS. 1-13. For example, the traction device may comprise a gliding seat 84, optionally including a pair of grip handles 82, configured to glide along a gliding track base 72, which may be supported by support legs 70, which may lift the device slightly off of the ground. A foot rest 74 may extend upwardly from the gliding track base 72 at an angle. A support bar 76, which may be similar to the rectangular tube 40, but which is stationary rather than moveable, may extend upward from the gliding track base 72, wherein the strap assembly 78 may extend from an end of the support bar 76 distal from the gliding track base 72. The strap assembly 78 may attach to a belt 80, which may be configured to wrap around a user's waist. To use the alternate embodiment, a user may lie on the gliding seat 84 with the belt 80 around his or her waist and push on the foot rest 74, causing the gliding seat 84 to glide along the length of the gliding track base 72.

Each component of the device may have any desired shape and size and may be connected to other components using any conventional fasteners. Because of the design of the device, the device may be portable and user friendly, and may not require a motor, but rather may be powered by muscle resistances from the user, applying a traction force to the lumbar spine in multiple planes.

To use the traction device, a user 68 may lay on the device, placing hips on the hip pad 30, torso on the torso pad 12, and head on the head rest pad 10. The user 68 may attach the belt 66 around the waist, attach the strap assembly to the belt 66, grip the handles 22, and place the feet on the foot rests 50. By extending the legs, the user may press on the foot rests 50, causing the strap assembly to apply traction to the belt 66 and, thus, to the user's back. Depending on the desired outcome of using the device, the user 68 may alter the traction provided to the belt 66 by moving the vector bar to various vectors from the user's midline, wherein the vector bar is configured to move to any desired vector, as shown in FIGS. 9 and 10.

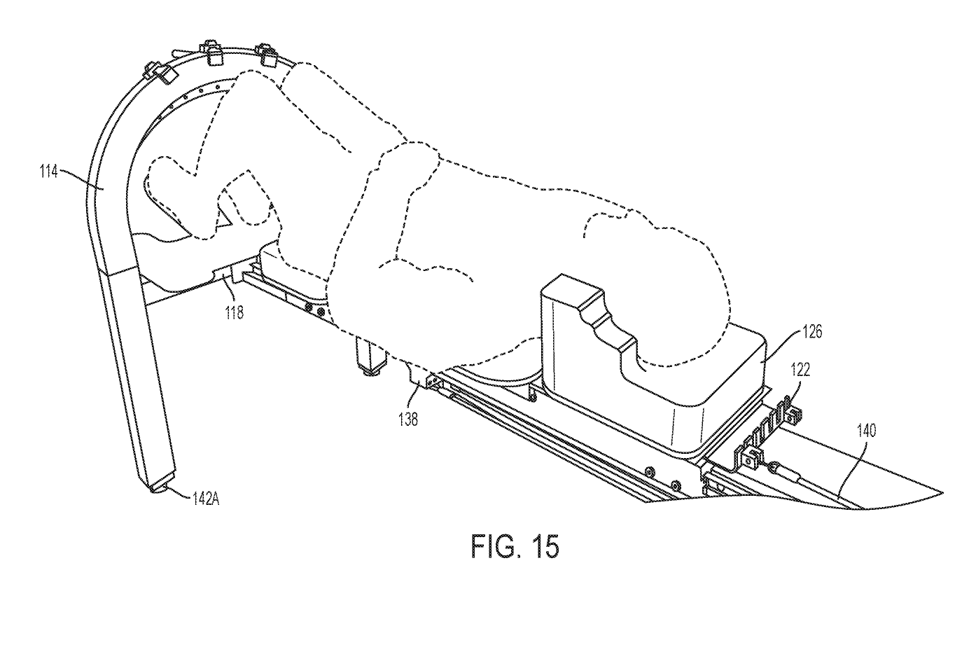

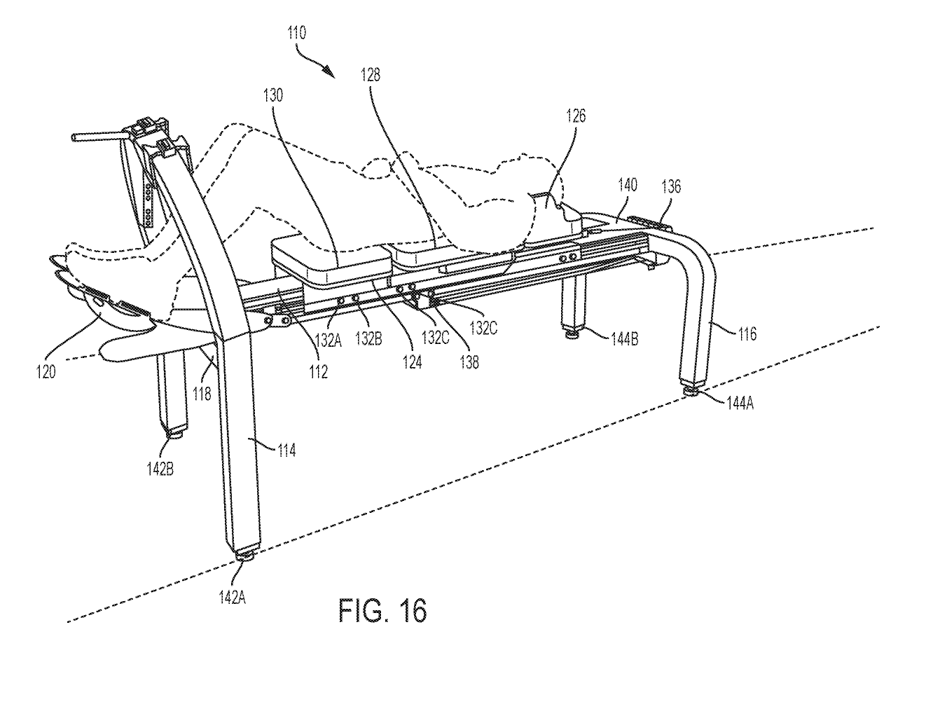

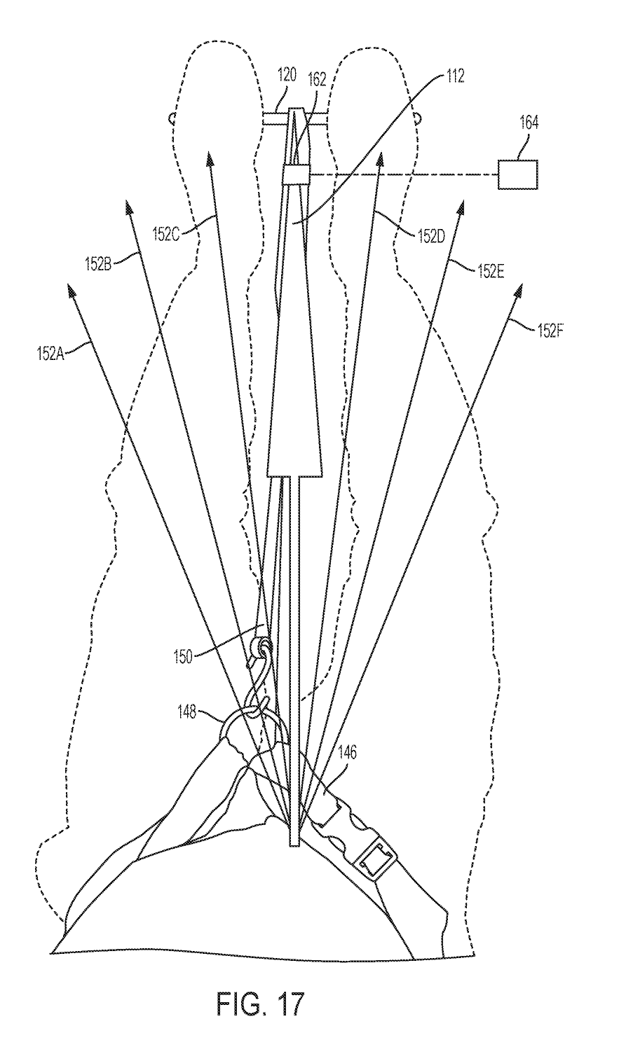

Turning to FIGS. 15-19, traction device 110 further comprises central support 112 connected to forward support 114 and rearward support 116. Central support 112 is connected to forward support 114 with cross member 118. Cross member 118 is attached to foot support 120.

Carriage 122 rests upon central support 112. Carriage 122 further comprises base 124. Base 124 is further attached to head rest 126, upper back pad 128 and lumbar pad 130. Base 124 is further attached to a plurality of wheels 132A, 132B, 132C, 132D which are configured to slide in track 134 attached to central support 112.

Rearward support 116 is further attached to tension cable rear support 136. Forward support 114 is further affixed to tension cable forward support 138. At least one tension cable 140 is attached to carriage 122, wraps around tension cable rear support 136 and is then affixed to tension cable forward support 138.

Forward support 114 further comprises forward support height adjustable feet 142A, 142B which can raise or lower forward support 114 relative to a ground surface G. Likewise, Rear support 116 further comprises rear support height adjustable feet 144A, 144B which can raise or lower rear support 116 relative to a ground surface G.

In some embodiments, belt 146 is wrapped around the user U at the waist and then attached to itself at ring 148. Ring 148 is attached to forward tension cable 150 which is then attached to forward support 114. The use of ring 148 is critical because it permits forward tension cable 150 to slide in a variety of directions that provides multiple vector auto traction 152A, 152B, 152C, 152D, 152E, 152F. In some embodiments, a handle 154 can be attached to carriage 122 to provide a user with additional stability. Forward tension cable can be attached to forward support 114 with force sensor 162. Force sensor 162 is communicatively coupled to digital display 164.

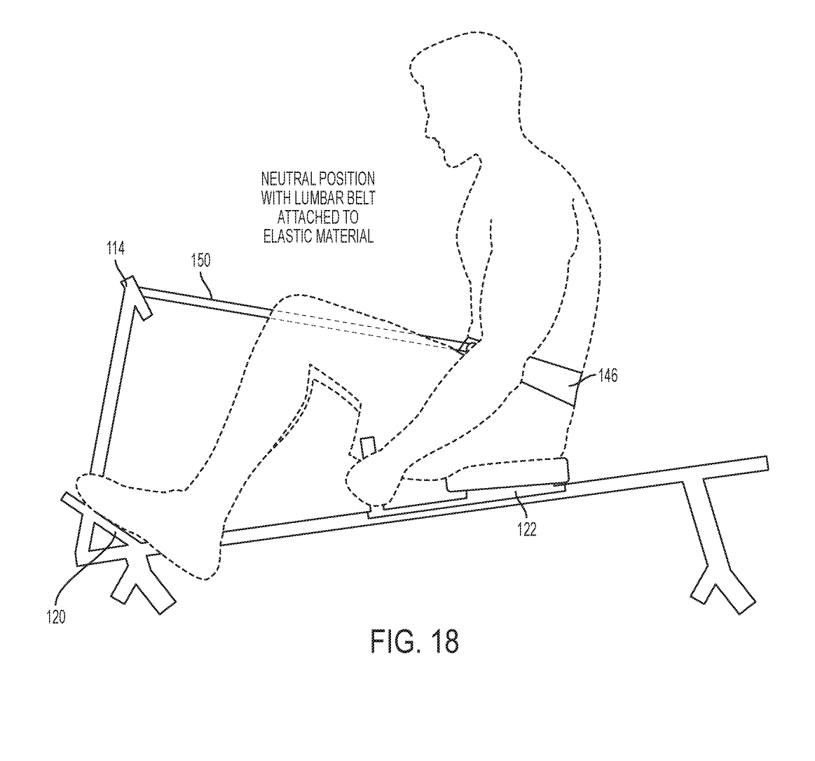

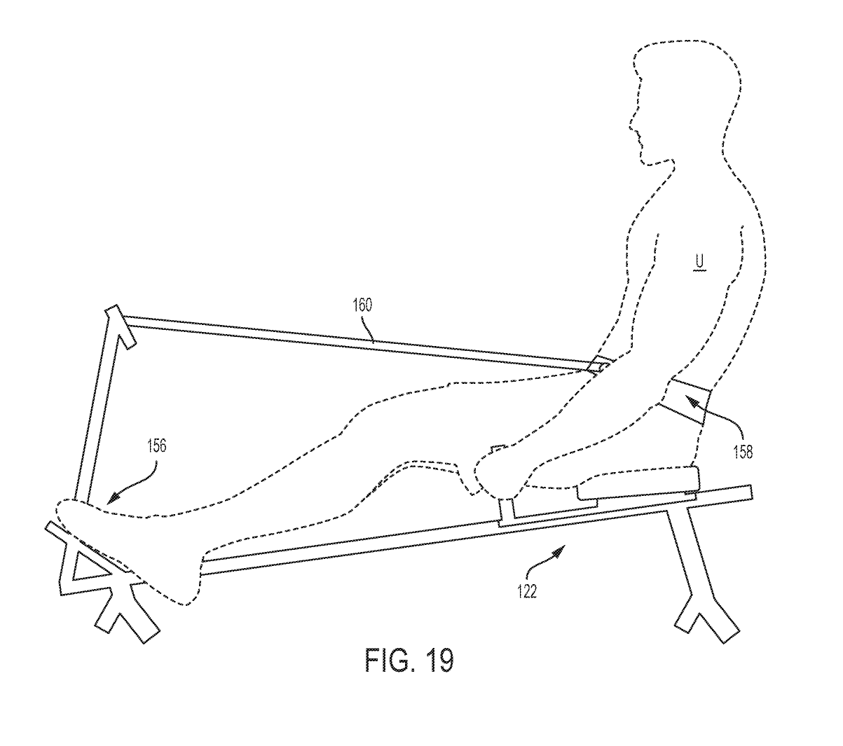

FIG. 18 shows a neutral position where belt 146 is attached to forward tension cable 150. In FIG. 19, user U applies leg press force 156 onto foot support 120. This causes carriage 122 to slide rearward. At the same time, lumbar traction 158 is applied to user U which forward tension cable 150 expands creating expansion force 160.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A traction device for relieving lower back pain and stiffness, the traction device comprising:
a central support connected to a forward support and a rearward support;
a foot support, connected to the forward support;
a carriage, resting upon the central support
a forward tension cable, attached to the forward support;
a belt, connected to the forward tension cable with a ring;
wherein a human user on the carriage, pushes the carriage distant the foot support causing tension on the forward tension cable that exerts a lumbar support force onto the belt.

2. The traction device of claim 1,
wherein the carriage further comprises:
a base, attached to a head rest, an upper back pad, and a lumbar pad;
a plurality of wheels, attached to the base;
a track, attached to the central support;
wherein the plurality of wheels are configured to slide in the track.

3. The traction device of claim 2, further comprising:
a tension cable head rest support attached to the head rest;
a tension cable rearward support, attached to the rearward support;
at least one tension cable, attached to the tension cable rearward support and the tension cable head rest support
wherein the at least one tension cable exerts a traction force toward the rearward support.

4. The traction device of claim 1, further comprising:
a tension cable rear support attached to the rearward support;
a tension cable forward support, attached to the forward support;
at least one tension cable, attached to the carriage, that wraps around the tension cable rear support and is then affixed to the tension cable forward support.
